(19) United States
(12) Patent Application Publication
(10) Pub. No.: US 2003/0195798 A1
(43) Pub. Date: Oct. 16, 2003

(54) Voter interface for electronic voting system

(76) Inventor: John Goci, Westland, MI (US)

Correspondence Address: DYKEMA GOSSETT PLLC, 39577 WOODWARD AVENUE, SUITE 300, BLOOMFIELD HILLS, MI, 48304-5086, US

(21) Appl. No.: 10/120,221

(22) Filed: Apr. 11, 2002

(51) Int. Cl. G06F 17/60

(52) U.S. Cl. 705/11

(57) ABSTRACT

A voting station in an electronic voting system is programmed for predetermined election contests taking place on a predetermined election day. The voting station includes a display screen for displaying textual and pictorial information and a user selection device for selecting items from said textual and pictorial information to indicate preferences of a voter. In one preferred embodiment, the display screen and user selection device is integrated as a touch-screen display. The display screen presents a slate of candidates for an elected office, each of the candidates being displayed as a selection item including at least a textual name identifier. The voter manipulates the user selection device to select a desired one of the candidates. Then the display screen presents an enlarged representation of information corresponding to the desired candidate together with a confirmation selection item and a cancel selection item. The voter manipulates the user selection device to select either the confirmation selection item or the cancel selection item. If the confirmation selection item is selected, then the display screen progresses through remaining election contests until the voter has confirmed a selection in each election contest. The display screen presents all voter selections on a review screen and presents choices to the voter to change any of the selections. After the voter confirms no further changes, the voting station outputs the voter selections.

### BACKGROUND OF THE INVENTION

The present invention relates in general to a programmable, electronic voting system, and, more specifically, to a user interface for such a voting system.

One of the most important foundations of a democracy is the right to vote. To ensure that each voter can effectively exercise that right and to ensure confidence in the results of any election, integrity of the process for casting and counting votes is paramount. The essential challenge is to achieve accurate identification of voter preferences while preserving voter anonymity.

Prior voting systems such as written paper ballots, punched cards, and mechanical switch panels have been overly complex and subject to numerous problems in connection with accurate recording and counting of votes. Due to the need to collect votes from a large number of voters in a short time, election officials have tried various techniques to reduce the time it takes for a voter to cast their ballot. Unfortunately, these have tended to create more voter confusion or have failed because of the deficiencies underlying the basic technologies used. The inaccuracies of vote counts and/or loss of votes that regularly occur have continued to raise much concern.

Electronic or computerized voting for governmental elections is now being investigated as an alternative for addressing some of the deficiencies of the prior art. However, a satisfactory system has remained elusive because of the many competing requirements for an acceptable voting system. For example, voter errors should be minimized or eliminated, but it is also desired that the amount of time required to complete a ballot should be a short as possible. Preferably, the vote must be maintained in a manner that allows a vote recount to take place. Public confidence in the integrity of electronic data storage, as well as the user friendliness of electronic or computer equipment and the “computer-phobia” felt by certain potential voters, must be taken into account. Furthermore, the readability (e.g., size) of text and/or non-native language abilities can create further confusion and errors. The foregoing problems have discouraged the adoption of electronic, computerized voting systems.

### SUMMARY OF THE INVENTION

The present invention provides a robust interface for an electronic voting system which reduces errors, builds voter confidence in electronic voting, and reduces the time it takes to complete a ballot, to tabulate vote counts, and to report them from local polling places to centralized authorities.

In one aspect of the invention, a method is provided for operating a voting station in an electronic voting system programmed for predetermined election contests taking place on a predetermined election day. The voting station includes a display screen for displaying textual and pictorial information and a user selection device for selecting items from said textual and pictorial information to indicate preferences of a voter. In one preferred embodiment, the display screen and user selection device is integrated as a touch-screen display. An identified voter is first authorized to cast an anonymous ballot using the voting station. The display screen presents a slate of candidates for an elected office, each of the candidates being displayed as a selection item including a textual name identifier and a photo. The voter manipulates the user selection device to select a desired one of the candidates. Then the display screen presents an enlarged representation of information corresponding to the desired candidate together with a confirmation selection item and a cancel selection item. The voter manipulates the user selection device to select either the confirmation selection item or the cancel selection item. If the cancel selection item is selected, then the display screen returns to presentation of the slate of candidates. If the confirmation selection item is selected, then the display screen progresses through remaining election contests until the voter has confirmed a selection in each election contest. The display screen presents all voter selections on a review screen and presents choices to the voter to change any of the selections. After the voter confirms no further changes, the voting station outputs the voter selections.

The voting system logic can also be applied to other processes such as surveying consumer acceptance of products.

### BRIEF DESCRIPTION OF THE DRAWINGS

FIG. 1 is a hardware diagram showing an architecture of an electronic voting system.

FIGS. 2 through 4 are flowcharts showing a preferred method of the present invention.

FIGS. 5 through 18 show the appearance of a touch-screen display during operation of a preferred embodiment of the present invention.

FIG. 19 shows an example of a hardcopy ballot generated by the present invention.

### DETAILED DESCRIPTION OF THE PREFERRED EMBODIMENTS

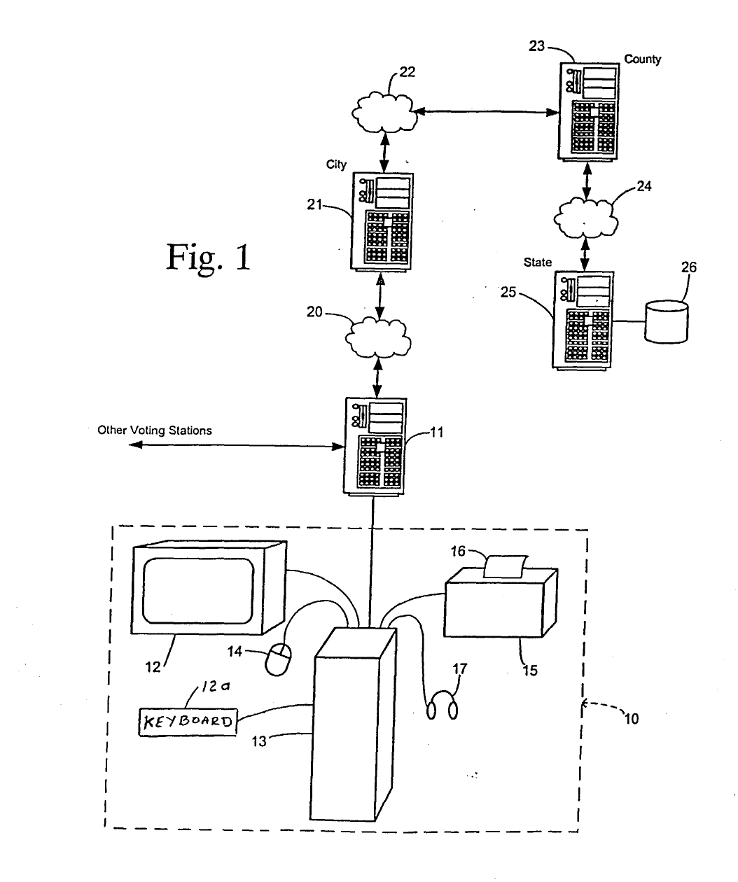

Referring to FIG. 1, an electronic voting system includes a voting station 10 coupled within a computer network to a local server 11 (e.g., located within a voting precinct or polling place and connected to other voting stations within the precinct). Voting station 10 is set-up to provide privacy during voting and includes a display monitor with integrated touch screen 12 connected to a workstation or personal computer 13 which is programmed to communicate with server 11 and to provide a voter interface for predetermined election contests taking place on a predetermined election day. Integrated display monitor/touch screen 12 displays textual and pictorial information and is responsive to voter manipulation for selecting items from the textual and pictorial information to indicate the voter's preferences. As an alternative to the touch screen selection device, a mouse 14 can be provided to make selections using the same graphical user interface on display monitor 12. A keyboard 12a with a Braille keyboard is attached to the computer for the visually handicapped.

For purposes of providing individual printed ballots reflective of the votes cast by each voter, a printer 15 is connected to computer 13 on which a ballot 16 is being printed. Headphones 17 are coupled to computer 13 which together provide an audio system that can be used to provide audible help to a voter (e.g., spoken instructions for those with limited reading literacy in the available languages or for those with eyesight limitations). For example, computer 13 includes a sound card and sound files have pre-recorded instructions in each of the predetermined languages.

Printed ballots may be collected and stored for use in vote recounts. Alternatively, the printed ballots could be collected and scanned using separate scanning equipment (not shown) for determining an official vote count for the respective precinct (e.g., if it is desired to electronically isolate the vote counting equipment). Preferably, the actual real-time vote tally is tabulated electronically via transmission over the computer network connection to precinct server 11. Server 11 is connected via a secure network 20 (e.g., a virtual private network or VPN over the Internet) to a city server in a city election office. The city server is also connected to other precinct servers (not shown). Server 21 is connected via a secure network 22 to a server 23 at the county level which collects vote data from the city servers within the county.

Likewise, a secure network 24 connects a server 25 in a state election office to all of the county servers. State server 25 is coupled to a master databank 26 for maintaining an official vote tabulation (e.g., for the state and federal election contests). A mainframe computer (not shown) may be provided for controlling database 26. Central vote accumulation may be performed at different levels depending upon the specific elective offices or the entities through which specific proposals are being made.

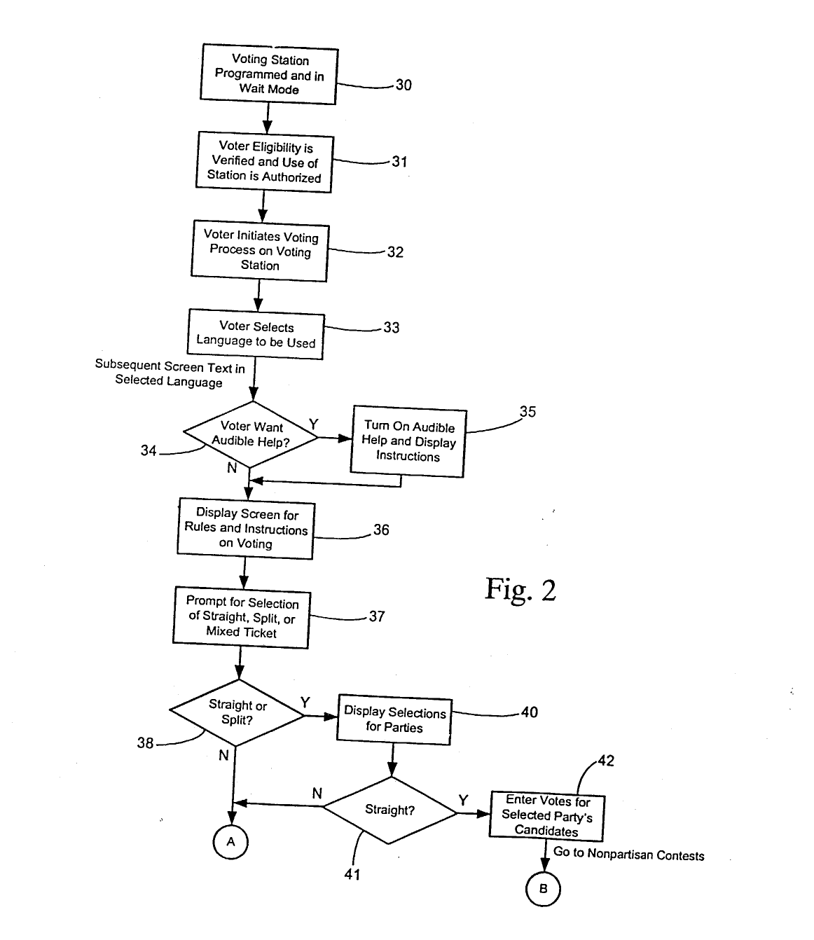

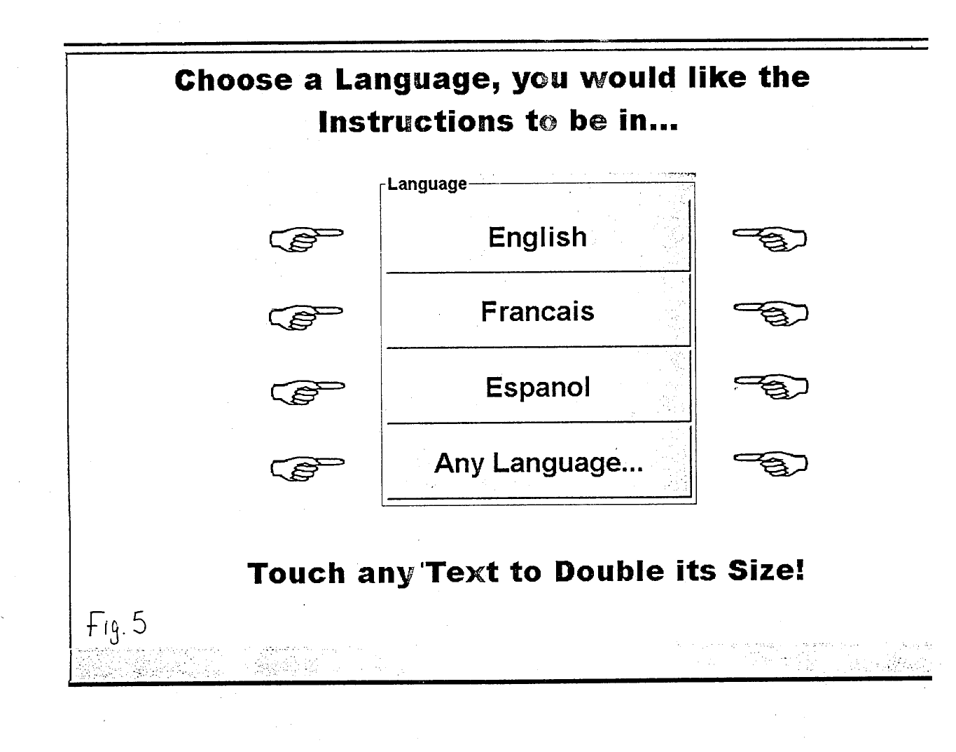

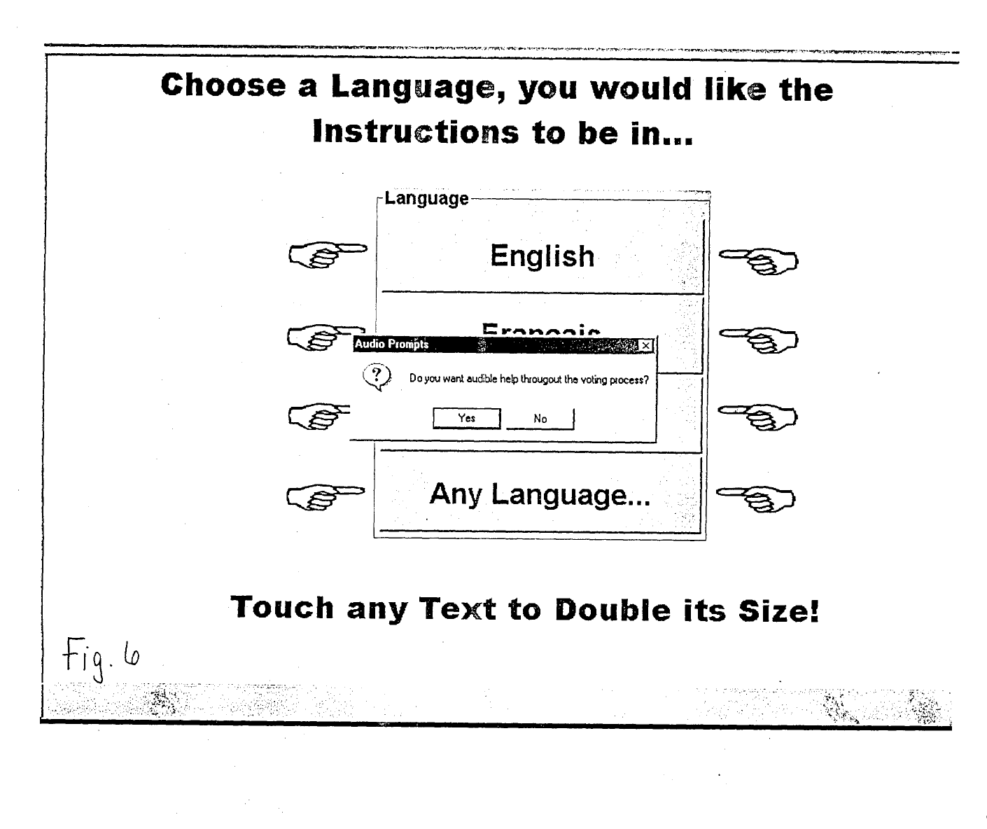

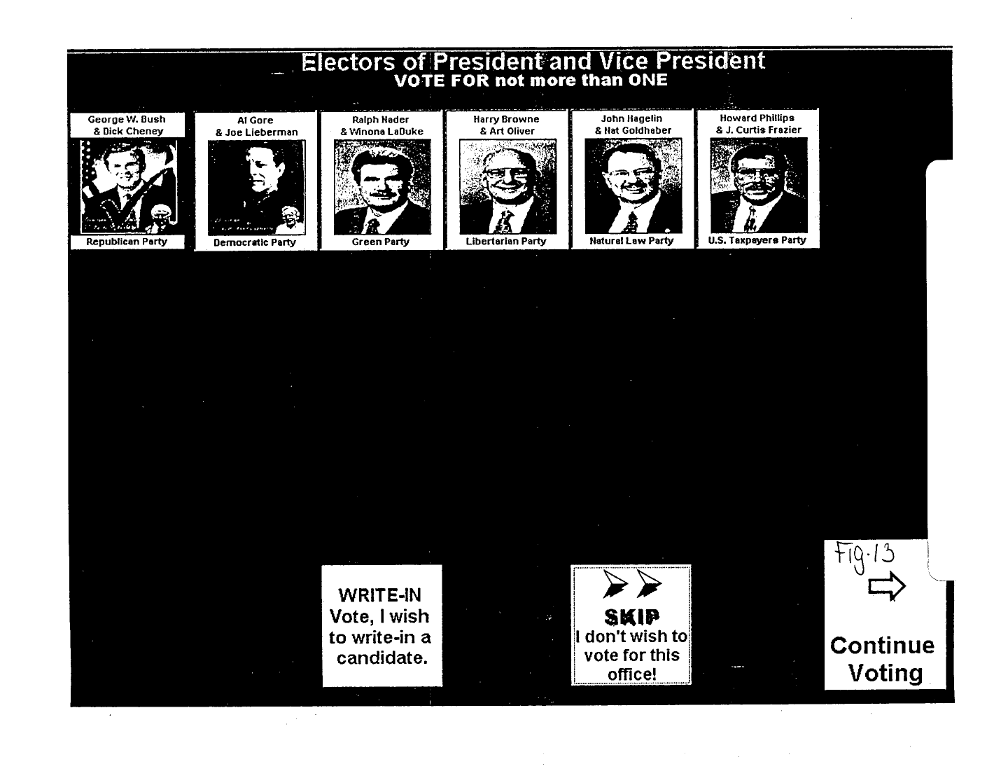

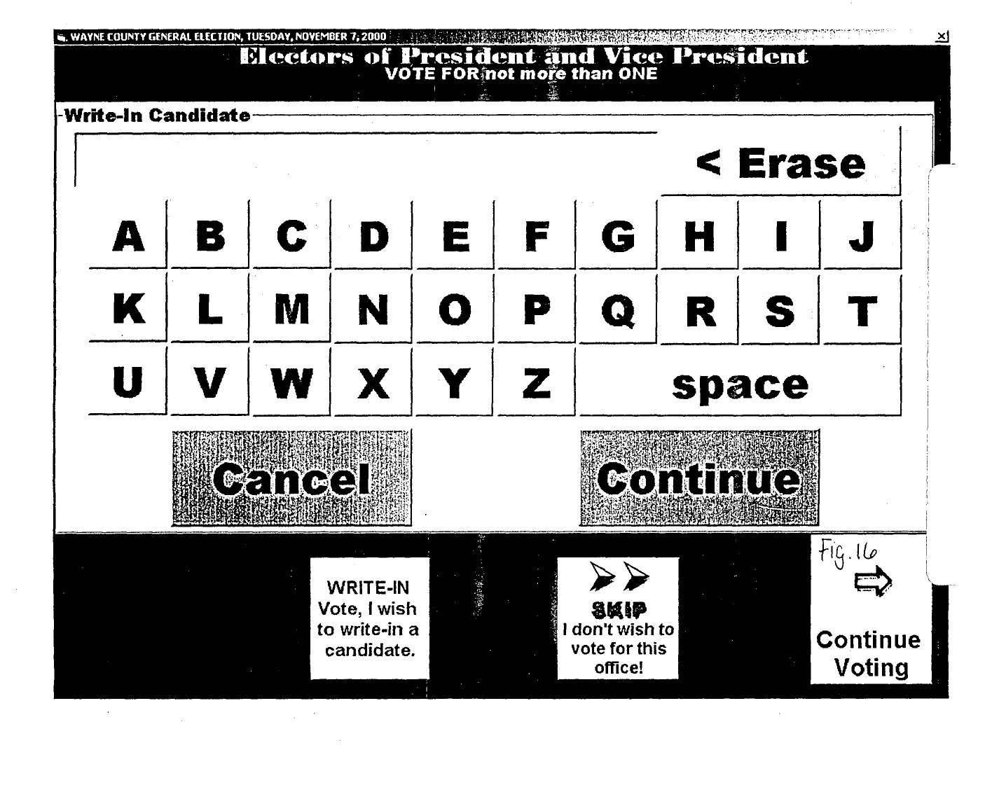

An operating method and an overall voter interface for the electronic voting system is shown in the flowcharts of FIGS. 2-4 which will be described in conjunction with the display contents (i.e., screen shots) in FIGS. 5-18.

Prior to use by a voter, a voting station is preprogrammed for the predetermined election contests (e.g., elected offices and ballot proposals) for an election being held on a predetermined election day. The voting station is initialized in a wait mode in step 30. A voter's identity and eligibility to vote are determined in step 31 and if eligible, then their use of the voting station is authorized. Identification and eligibility may be determined in any suitable manner, such as by presentation and manual acceptance of a signed voter's card or by electronic identification using fingerprints or other identifying characteristics. Identification and authorization may be conducted by the voting station itself. During the time that the voting station is in the wait mode, the display screen may show a message saying “Waiting for Next Voter. If You Need Help, Please Ask an Election Worker”. In step 32, an authorized voter approaches a voting station and initiates the process of voting.

In step 33, a voter selects the language that they prefer to use in the voting process. As shown in FIG. 5, a language selection screen (presented in a default language, such as English) includes selection items 100 (i.e., menu buttons) corresponding to the preprogrammed languages available. The voter may touch a desired button so that all subsequent screen text or other written instructions are provided in the desired language. In one preferred embodiment, the screen in FIG. 5 also alerts a voter to the fact that any text shown on a display screen (other than a selection item) can be enlarged (e.g., doubled in size) for making it easier to read by simply selecting (e.g., touching) the text.

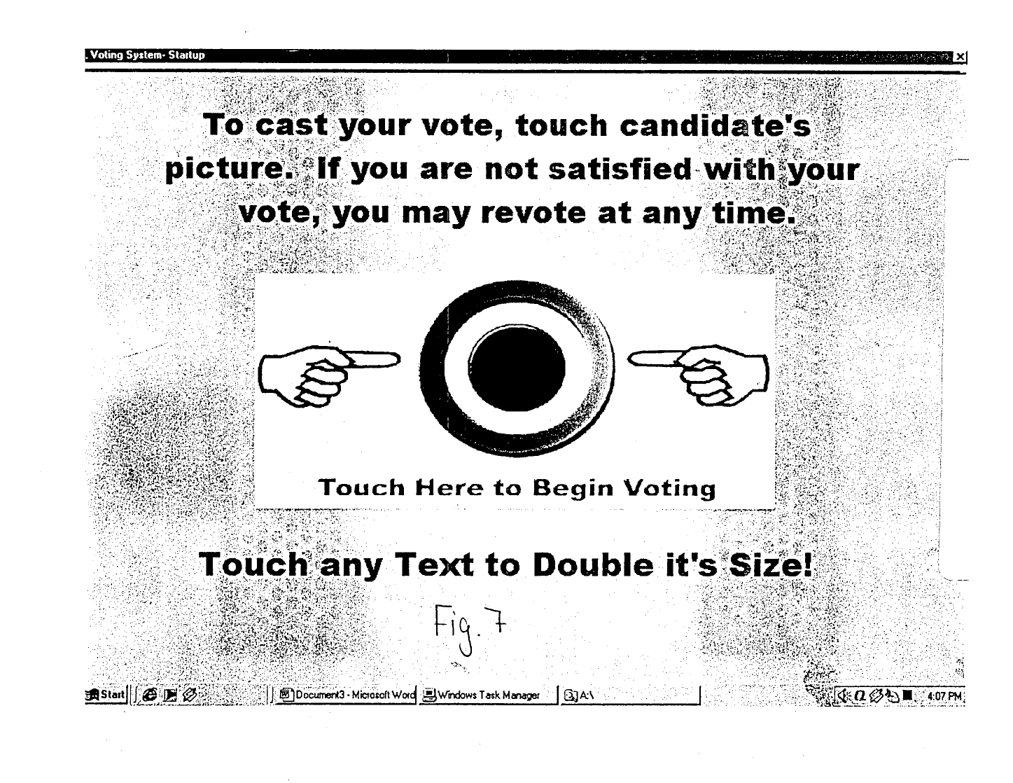

After a language is selected, the voter is prompted to indicate whether they desire audible (i.e., audio) help in step 34. The corresponding display screen is shown in FIG. 7. If audible help is desired, then the audible help function is turned on in step 35 while instructions for using the audio system (e.g., to put on the headphones) are displayed. If audio is turned on, then all subsequent display text or a predetermined portion thereof are audibly reproduced.

Once a language and the use of audible help are established, the instructions, any other text displays, and any audible help are provided in the selected language. Voting rules and instructions are presented to the voter in step 36. For example, FIG. 7 shows a screen explaining that to cast a vote for a candidate, the candidate's picture should be touched on the touch screen. After reading this explanation, the voter touches a target area to proceed to vote.

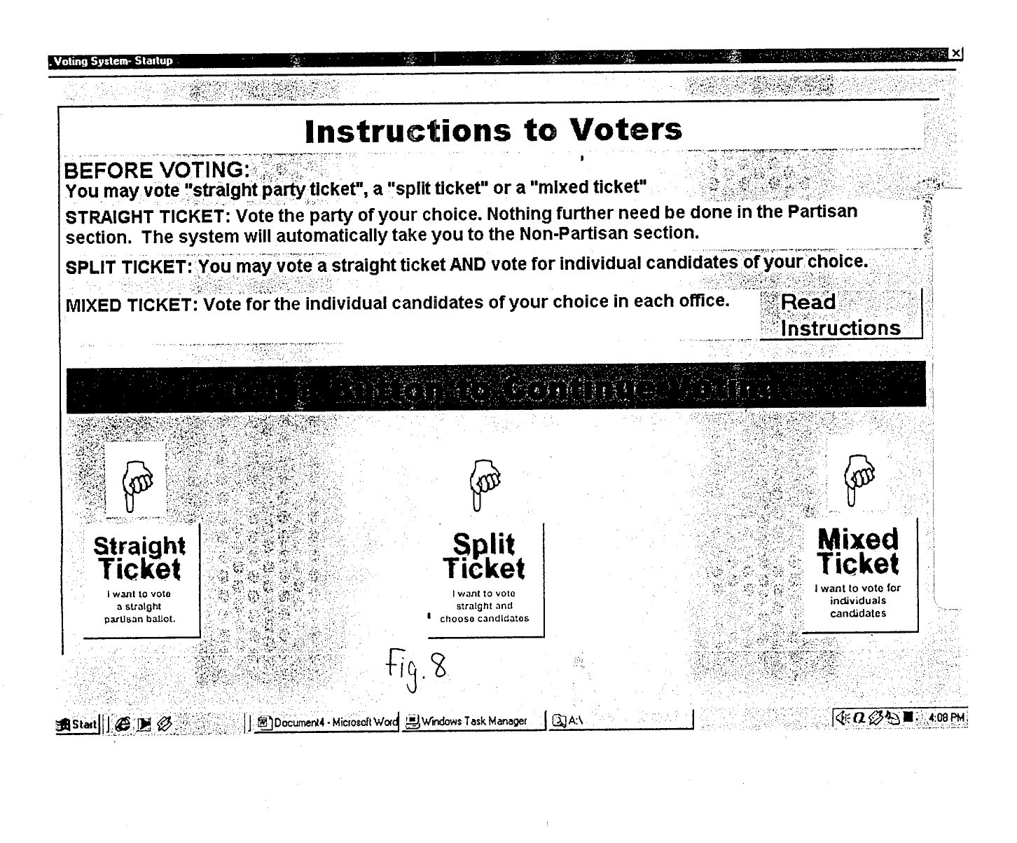

In step 37, the voter is prompted to select a voting mode from the choices of straight party ticket, split ticket, or mixed ticket. The corresponding screen is shown in FIG. 8. As explained on the screen, the straight party ticket mode allows the voter to choose a party. All votes are cast in the partisan portion of the election for candidates of the chosen party. Then the voter is taken to any nonpartisan or proposal sections of the election contests. In the split ticket mode, the votes for the partisan contests are initialized for candidates of the selected party but each contest is presented to the voter so that any individual votes can be changed. In mixed ticket mode, each contest is presented without any initialization of the votes.

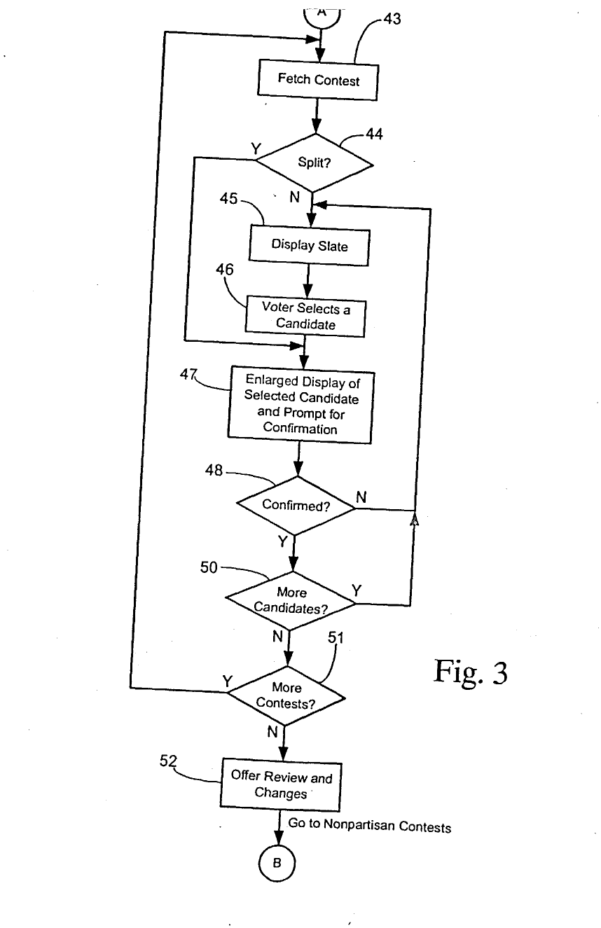

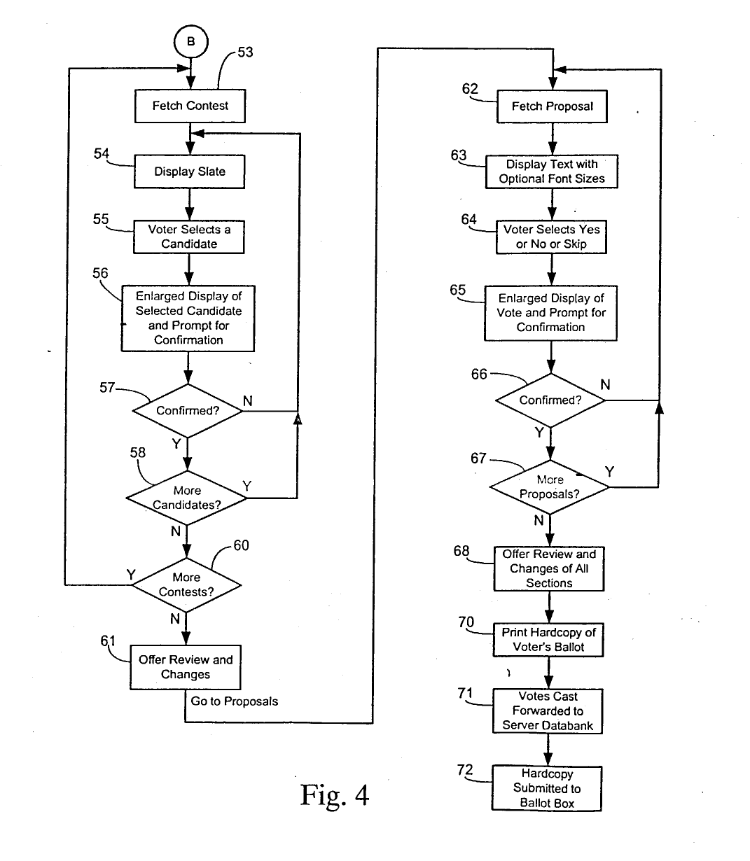

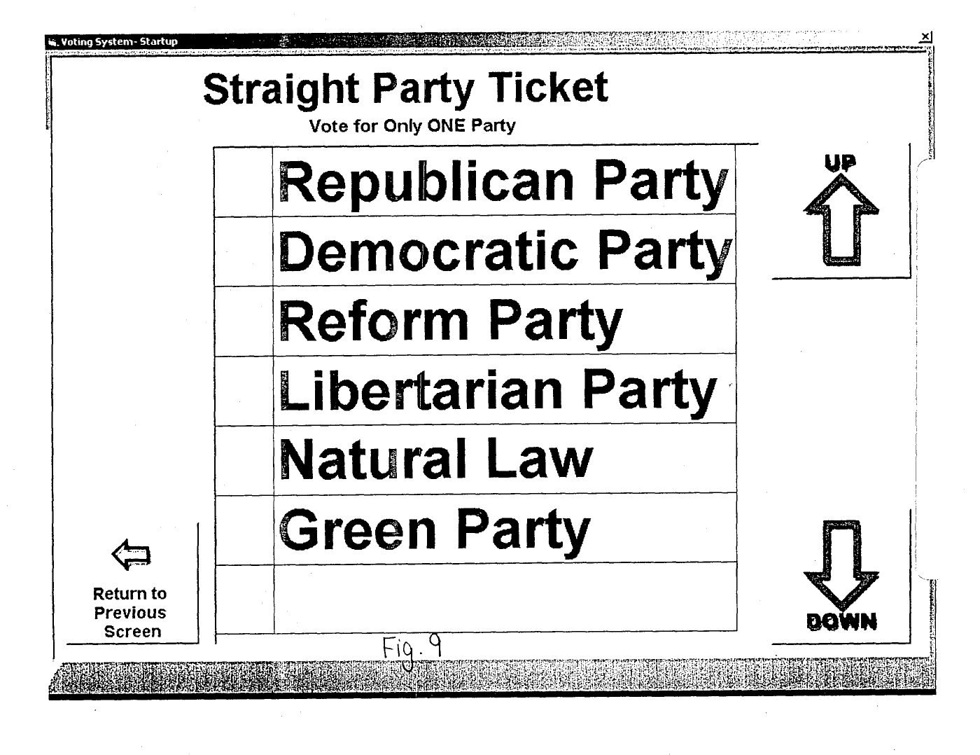

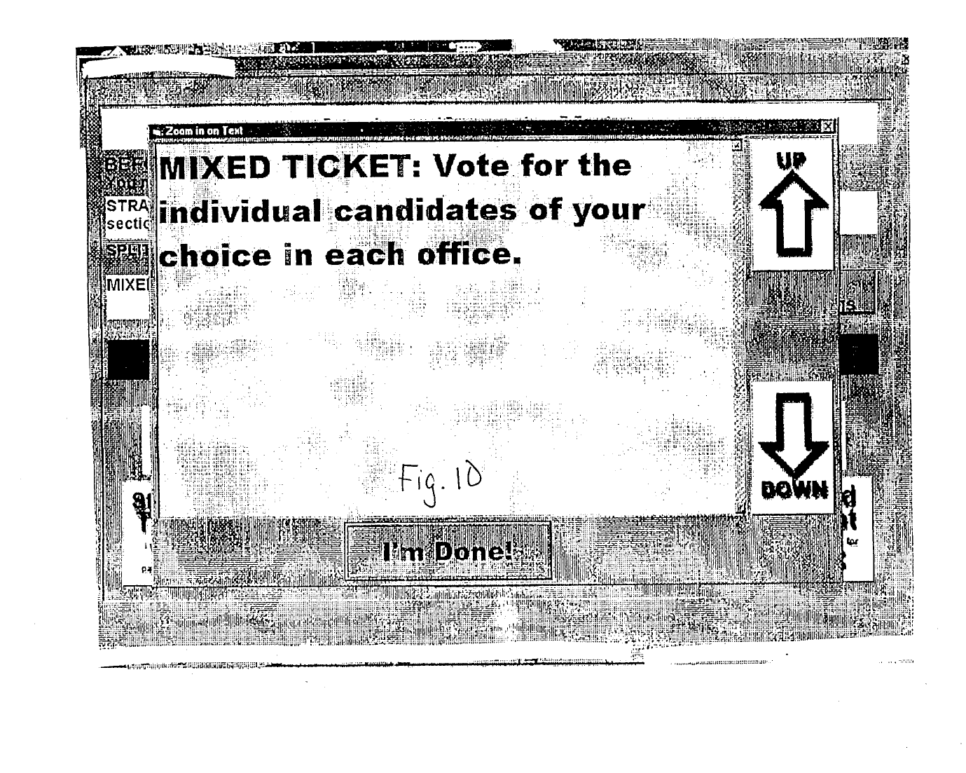

The voter selects “straight ticket” selection item 101, “split ticket” selection item 102, or “mixed ticket” selection item 103 on the screen of FIG. 8. In the operating method of FIG. 2, a check is made in step 38 to determine if the voter has selected either a straight ticket or a split ticket. If so, then the available political parties are displayed in step 40 and the voter touches the name of the desired party (the corresponding screen is shown in FIG. 9). A check is made in step 41 to determine if the straight ticket mode is selected. If it is, then votes are entered for the candidates of the selected party in step 42 and the method proceeds to any nonpartisan election contests at point B (which links to FIG. 4). If step 38 detects mixed ticket mode or if step 41 detects split ticket mode, then the method proceeds to the partisan election contests at point A (which links to FIG. 3). Additional instructions for the split ticket and mixed ticket modes may be shown, such as a mixed ticket message shown in FIG. 10.

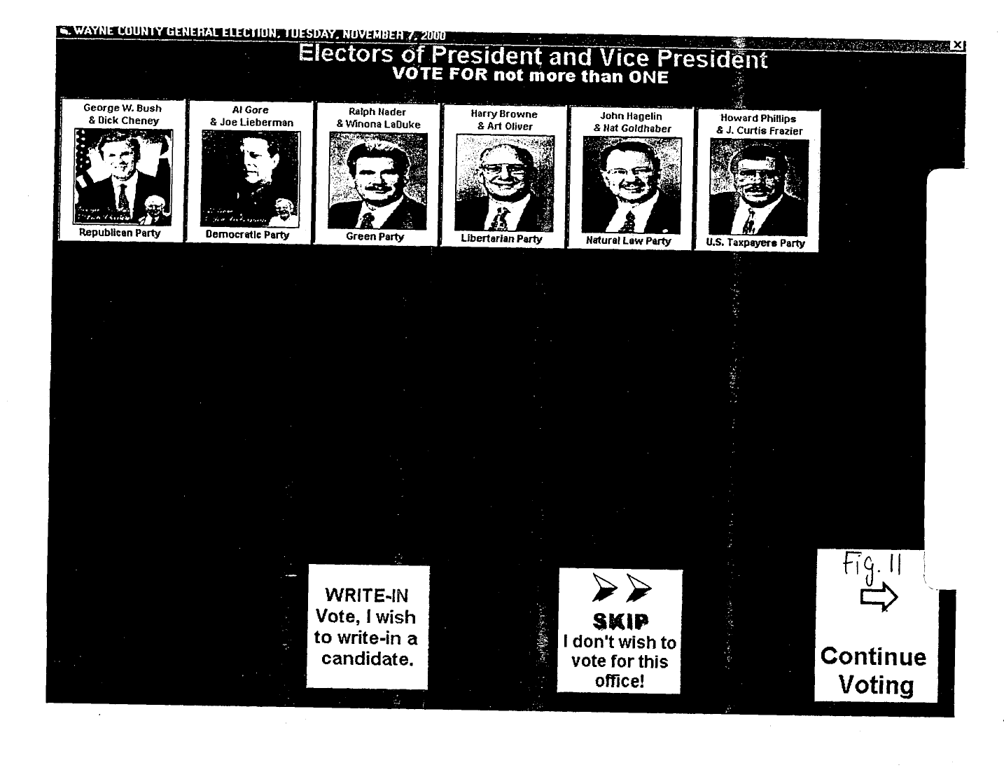

Proceeding from point A in FIG. 3, a first partisan contest is fetched in step 43. A check is made in step 44 for the split ticket mode. If not in split ticket mode (i.e., mixed ticket mode is active), then a slate of candidates for the current election contest is displayed in step 45. Each candidate is identified by at least a textual name identifier and preferably by a name, picture, and political party as shown in the screen view of FIG. 11. In step 46, the voter selects a candidate by touching the selection item block (containing the candidate's name, picture, and party) of their choice. Additional selection items may be provided for writing-in the name of a candidate (if appropriate) or for skipping the current election contest without entering a vote. If step 44 determines that voting is in split ticket mode (i.e., a preferred political party has been chosen), then the vote for the current contest is initialized to the candidate(s) of the chosen party and the method proceeds directly from step 44 to step 47.

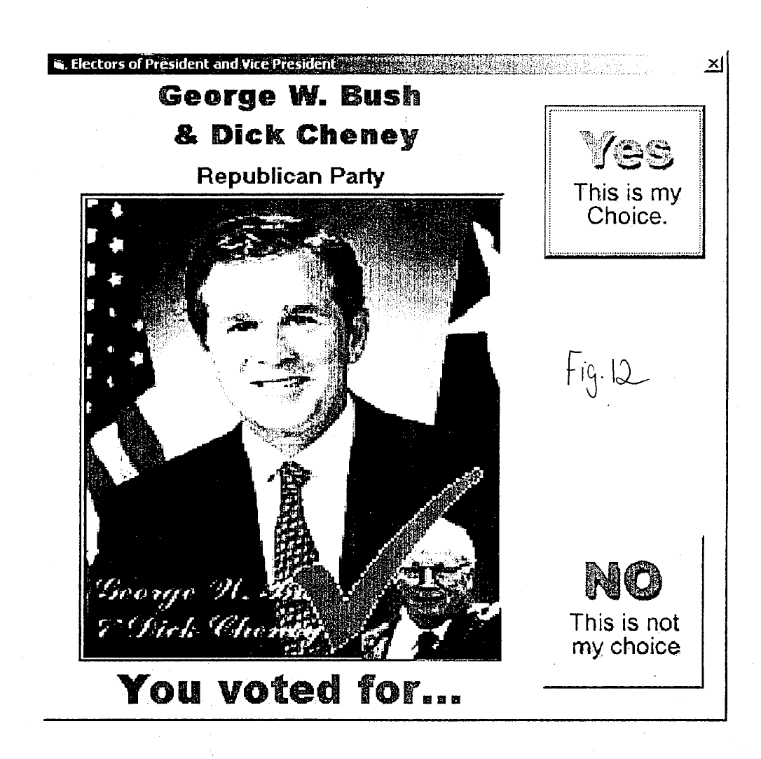

In step 47, an enlarged display (e.g., between one-quarter screen and full screen as shown in FIG. 12) of the selected candidate is presented to the voter along with a confirmation selection item (e.g., the “yes” button in FIG. 12) and a cancel selection item (e.g., the “no” button in FIG. 12). Step 48 waits for the voter to select one of the buttons, and if the candidate selection is cancelled then a return is made to step 45 to re-display the slate of candidates. If the candidate selection is confirmed, then a check is made in step 50 to determine whether more candidates from the slate can be selected (i.e., the election contest is for multiple seats). If more candidates can be selected, then a return is made to step 45 wherein the slate of candidates is re-displayed with an indication of the candidate(s) already selected (e.g., highlighting or shading of a deactivated selection item block for the already chosen candidate).

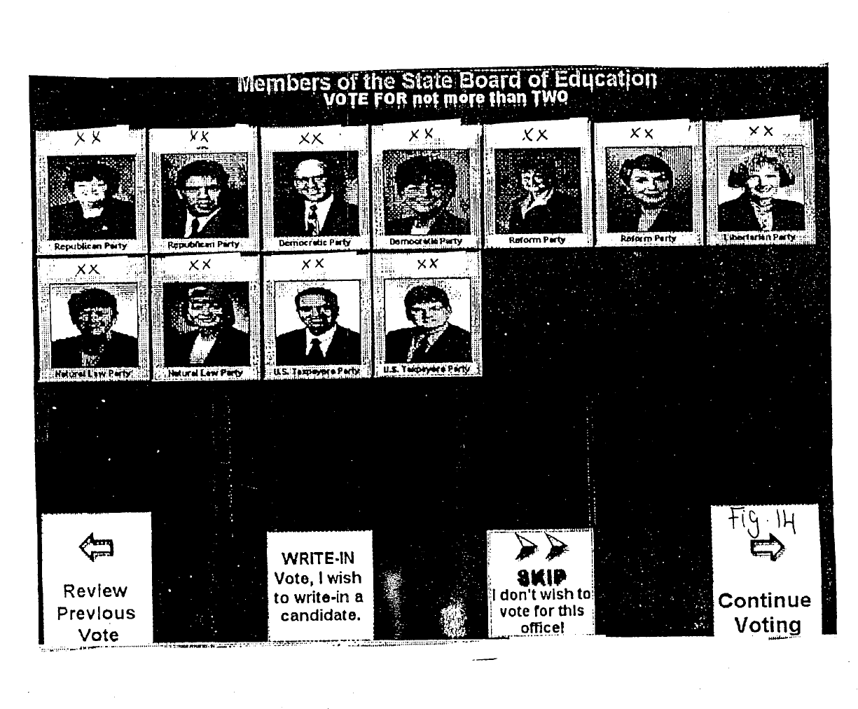

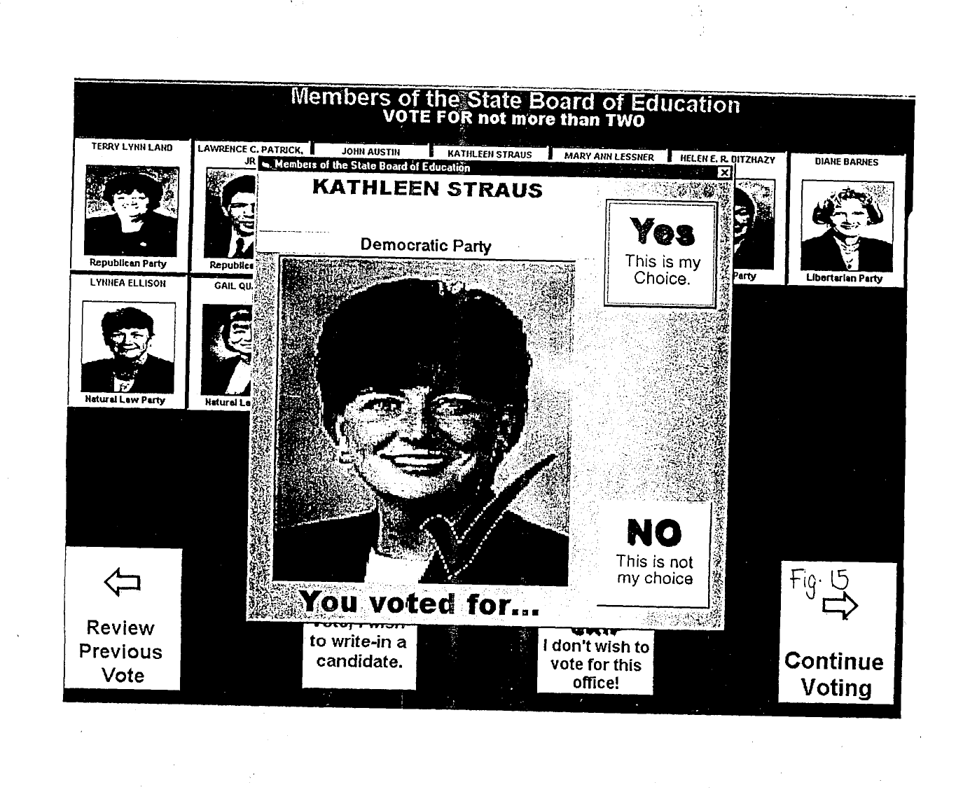

If no more candidates can be selected (or if the voter skips any further selections), then a check is made in step 51 to determine whether there are additional partisan election contests to be voted. If so, then a return is made to step 43 to fetch the next contest. FIG. 14 demonstrates a slate for further partisan contests for which votes can be cast for only one candidate. FIG. 15 shows an enlarged display for confirming a vote for one of the candidates on this slate.

If there are no further partisan contests, then a summary screen may be presented to the voter in step 52 to allow review and/or changes to the votes cast. Alternatively, the method may proceed directly to any nonpartisan contests at point B and any review or changes can be done once after all votes have been cast on the entire ballot.

Voting for nonpartisan contests begins at point B in FIG. 4. The first nonpartisan contest is fetched in step 53. A slate of candidates for the nonpartisan contest is displayed in step 54. In step 55, the voter selects a candidate by touching the selection item block containing the candidate's name, picture, and party of their choice. In step 56, an enlarged display of the selected candidate is presented to the voter along with a “yes” button and a “no” button. If the selection is not confirmed in step 57, then a return is made to step 54 to re-display the slate of candidates. If the candidate selection is confirmed, then a check is made in step 58 to determine whether more candidates from the slate can be selected. If more candidates can be selected, then a return is made to step 54 wherein the slate of candidates is re-displayed with an indication of the candidate(s) already selected.

After no more candidates can be selected (or if the voter skips any further selections), then a check is made in step 60 to determine whether there are additional nonpartisan election contests to be voted. If so, then a return is made to step 53 to fetch the next contest. Otherwise, a summary/change screen may be presented to the voter in step 61.

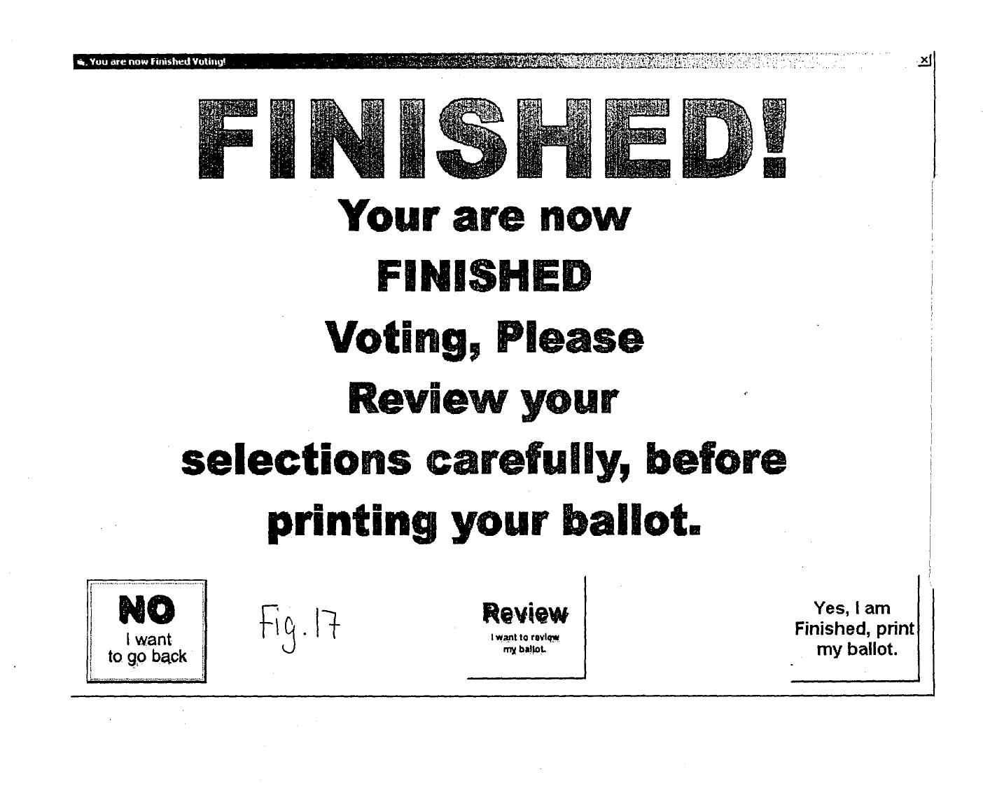

Thereafter, the method proceeds to voting on any proposals (i.e., ballot initiatives) included in the election contests that are decided by yes or no votes. In step 62, a first proposal is fetched. In step 63, the approved text of the proposal is displayed on the touch screen monitor. An optional font size can be selected so that the text can be enlarged to any extent necessary to allow it to be read by voters with poor visual acuity. The voter selects a yes vote, a no vote, or skips voting on the proposal in step 64. An enlarged display of the desired selection is shown in step 65 along with confirmation and cancel buttons. If not confirmed, then the text of the proposal is re-displayed in step 63. Otherwise, a check is made in step 67 to determine whether there are additional proposals to be voted on. If there are more, then a return is made to step 62 to fetch the next proposal. If there are no more proposals, then voting selections are finished. FIG. 17 shows a screen that is displayed to inform the voter that their ballot is completed and that their selections can be reviewed prior to printing and submitting their votes.

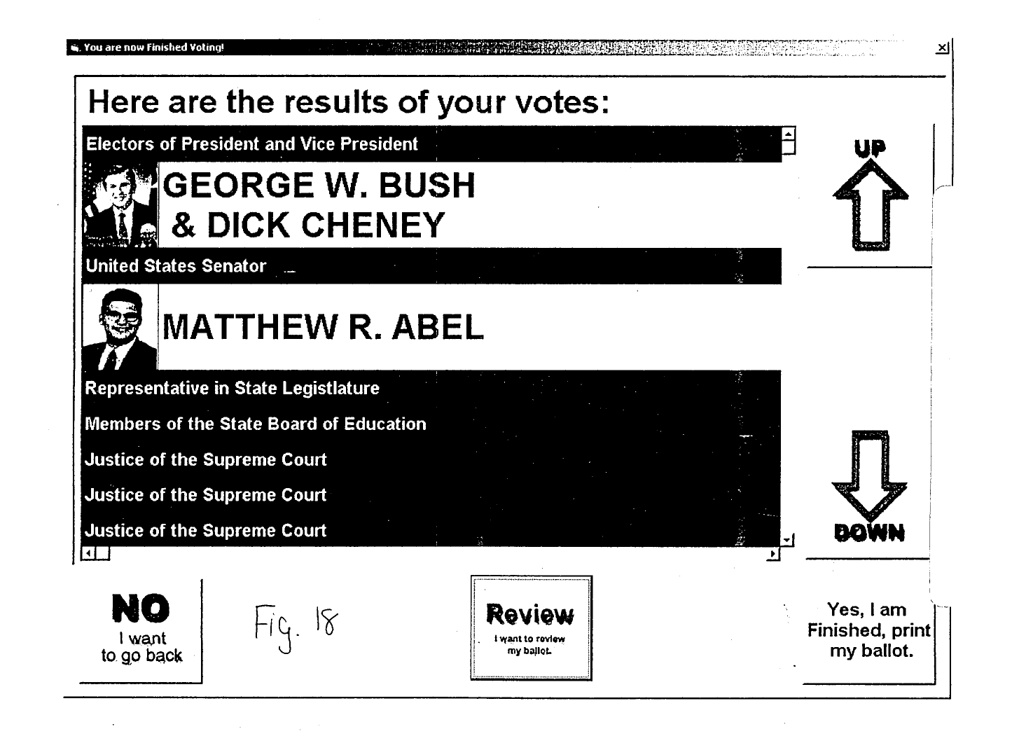

Unless the voter chooses not to review any selections, a summary and change screen is presented in step 68. FIG. 18 shows a summary pop-up window overlying the screen of FIG. 17. The summary window shows each election contest and any selections that have been made by the voter. If the voter has selected the wrong candidate, in error, he touches the NO name to go to the beginning of the process, then touches SKIP until he reaches the vote he wants to change. When a new selection is made and confirmed, the method returns to the summary window of FIG. 18.

After the voter has completed any review, they touch a selection item to indicate that they are finished and that they wish to print their ballot. A hardcopy of the ballot is printed in step 70. In an embodiment wherein the votes cast are tabulated electronically directly from the voting stations, the votes cast are transmitted to a server databank in step 71 concurrently with printing the hardcopy. The hardcopy ballot is submitted to a ballot box in step 72 (e.g., for purposes of a recount or as an original ballot for an official vote count if desired). Preferably, the hardcopy ballot may be retrieved by the voter from the printer and delivered personally to a ballot box, thereby increasing the confidence level of many voters in the integrity of the voting system since they experience something physically tangible showing their votes. Once the voter leaves the voting station, the display reverts to the wait screen of FIG. 5.

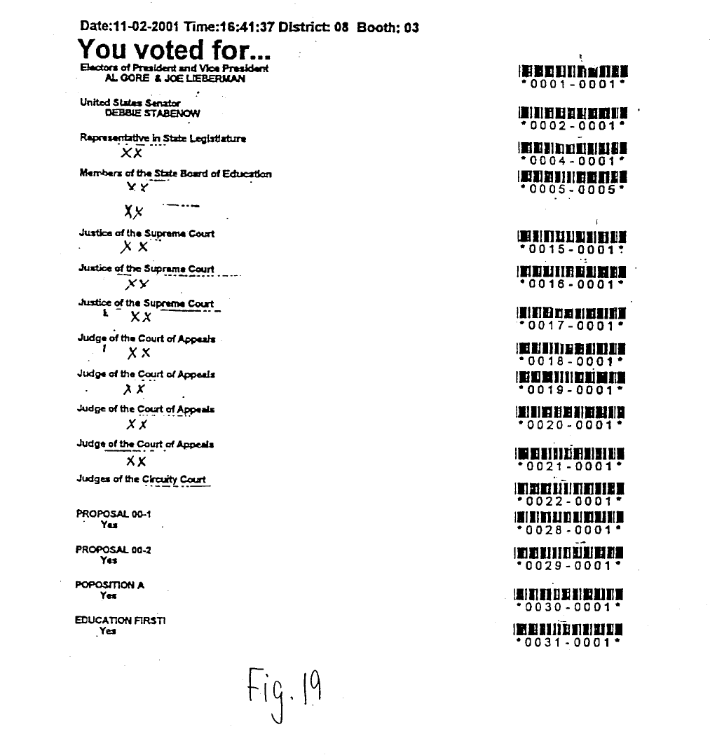

To improve counting and handling of hardcopy ballots, each election contest and selected candidate or other result of a vote may preferably be printed on the hardcopy ballots by means of a barcode or other electronically scannable symbols. A sample hardcopy ballot is shown in FIG. 19.

Many obvious modifications and adaptations of the foregoing embodiments will be apparent to those skilled in the art. Any such modifications or adaptations are intended to be covered by the appended claims. For example, certain elections may not include contests in all the categories of partisan contests, nonpartisan contests, and proposals, and the voting interface would be programmed to skip the corresponding sections of the foregoing method. In addition, the invention could be used with remote identification and verification (such as fingerprint ID as described above) to achieve Internet voting, for example.

Having described my invention, I claim:

1. A method for operating a voting station in an electronic voting system programmed for predetermined election contests taking place on a predetermined election day, said voting station including a display screen for displaying textual and pictorial information and a user selection device for selecting items from said textual and pictorial information to indicate preferences of a voter, said method comprising the steps of:
authorizing an identified voter to cast an anonymous ballot using said voting station;
said display screen presenting a slate of candidates for an elected office, each of said candidates being displayed as a selection item including at least a textual name identifier and an image;
said voter manipulating said user selection device to select a desired one of said candidates;
said display screen presenting an enlarged representation of information corresponding to said desired candidate together with a confirmation selection item and a cancel selection item;
said voter manipulating said user selection device to select either said confirmation selection item or said cancel selection item;
if said cancel selection item is selected, then returning to presentation of said slate of candidates;
if said confirmation selection item is selected, then progressing through remaining election contests until said voter has confirmed a selection in each election contest;
said display screen presenting all voter selections on a review screen and presenting choices to said voter to change any of said selections;
said voter confirming no further changes; and
said voting station outputting said voter selections.

2. The method of claim 1 wherein said predetermined election contests include a plurality of partisan election contests with candidates representative of a plurality of political parties, and wherein said method further comprises the steps of:
offering said voter a selection of a straight ticket mode, a split ticket mode, or a mixed ticket mode;
wherein said straight ticket mode is comprised of said voter selecting a desired one of said political parties and entering voter selections for all of said partisan election contests to candidates of said desired political party;
wherein said split ticket mode is comprised of said voter selecting a desired one of said political parties, initializing voter selections for all of said partisan election contests to candidates of said desired political party, and displaying each of said partisan election contests individually such that an enlarged representation of information corresponding to said initialized selection is presented together with a confirmation selection item and a cancel selection item; and
wherein said mixed ticket mode proceeds without selection of one of said political parties and without initializing any voter selections.

3. The method of claim 1 wherein said outputting step is comprised of said voting station transmitting said voter selections to a central vote accumulator via a computer network.

4. The method of claim 1 wherein said voting station further includes a printer and wherein said method further comprises the step of generating a printed ballot recording said voter selections.

5. The method of claim 4 wherein said printed ballot is collected from said voter and is retained for purposes of validation and recount.

6. The method of claim 4 wherein said printed ballot includes barcode identification of each of said voter selections to facilitate automated recounts.

7. The method of claim 1 wherein said voting station is adapted to present said textual information in a selected one of a plurality of languages, and wherein said method further comprises the steps of:
said display screen presenting a language selection menu;
said voter manipulating said user selection device to select a desired one of said languages; and
said textual information thereafter being presented in said selected language.

8. The method of claim 1 wherein said voting station further includes an audio system having headphones and programmed to provide audible help information corresponding to said textual information to assist said voter, and wherein said method further comprises the steps of:
said display screen presenting an audible help selection item;
said voter manipulating said user selection device to either accept or decline said audible help; and
if said audible help is accepted, then said display screen displaying an instruction to said voter to wear said headphones and said audio system reproducing said audible help information synchronized with said displayed textual and pictorial information.

9. The method of claim 8 wherein said voting station is adapted to present said textual information and said audible help information in a selected one of a plurality of languages, and wherein said method further comprises the steps of:
said display screen presenting a language selection menu;
said voter manipulating said user selection device to select a desired one of said languages; and
said textual information and said audible help information thereafter being presented in said selected language.

10. The method of claim 1 wherein each of said selection items for a candidate includes a respective picture, name, and party membership of said candidate.

11. The method of claim 1 wherein said election contests include a yes/no proposal and wherein said method further comprises the steps of:
said display screen presenting text of said proposal;
said display screen presenting an option to enlarge said presented text of said proposal;
said voter manipulating said user selection device to select said option to enlarge said text;
said display screen presenting said enlarged text, a yes-selection item, and a no-selection item; and
said voter manipulating said user selection device to select a desired one of said yes-selection item or said no-selection item.

12. The method of claim 1 wherein said step of authorizing an identified voter is comprised of fingerprint matching performed by said voting station.

13. The method of claim 1 wherein said display screen and said user selection device are comprised of a touch-screen device.

14. The method of claim 1 wherein said voting station is comprised of a personal computer.

15. A voting station in an electronic voting system comprising:
a programmable computer programmed for predetermined election contests taking place on a predetermined election day;
a display screen for displaying textual and pictorial information; and
a user selection device for selecting items from said textual and pictorial information to indicate preferences of a voter;
wherein said programmable computer is programmed to perform the steps of:
authorizing an identified voter to cast an anonymous ballot using said voting station;
said display screen presenting a slate of candidates for an elected office, each of said candidates being displayed as a selection item including at least a textual name identifier;
said voter manipulating said user selection device to select a desired one of said candidates;
said display screen presenting an enlarged representation of information corresponding to said desired candidate together with a confirmation selection item and a cancel selection item;
said voter manipulating said user selection device to select either said confirmation selection item or said cancel selection item;
if said cancel selection item is selected, then returning to presentation of said slate of candidates;
if said confirmation selection item is selected, then progressing through remaining election contests until said voter has confirmed a selection in each election contest;
said display screen presenting all voter selections on a review screen and presenting choices to said voter to change any of said selections;
said voter confirming no further changes; and
said voting station outputting said voter selections.

16. The voting station of claim 15 wherein said predetermined election contests include a plurality of partisan election contests with candidates representative of a plurality of political parties and wherein said programmable computer is programmed to perform the steps of:
offering said voter a selection of a straight ticket mode, a split ticket mode, or a mixed ticket mode;
wherein said straight ticket mode is comprised of said voter selecting a desired one of said political parties and entering voter selections for all of said partisan election contests to candidates of said desired political party;
wherein said split ticket mode is comprised of said voter selecting a desired one of said political parties, initializing voter selections for all of said partisan election contests to candidates of said desired political party, and displaying each of said partisan election contests individually such that an enlarged representation of information corresponding to said initialized selection is presented together with a confirmation selection item and a cancel selection item; and
wherein said mixed ticket mode proceeds without selection of one of said political parties and without initializing any voter selections.

17. The voting station of claim 15 wherein said programmable computer is coupled to a computer network and wherein said programmable computer transmits said voter selections to a central vote accumulator.

18. The voting station of claim 15 further comprising a printer for generating a printed ballot recording said voter selections.

19. The voting station of claim 15 wherein said programmable computer is adapted to present said textual information in a selected one of a plurality of languages, and wherein said display screen presents a language selection menu, said voter manipulates said user selection device to select a desired one of said languages; and said textual information is thereafter presented in said selected language.

20. The voting station of claim 15 further including an audio system having headphones and programmed to provide audible help information corresponding to said textual information to assist said voter, and wherein said programmable computer is further programmed to perform the steps of:
said display screen presenting an audible help selection item;
said voter manipulating said user selection device to either accept or decline said audible help; and
if said audible help is accepted, then said display screen displaying an instruction to said voter to wear said headphones, and said audio system reproducing said audible help information synchronized with said displayed textual and pictorial information as the voter chooses.

21. The voting station of claim 20 wherein said programmable computer is adapted to present said textual information in a selected one of a plurality of languages, and wherein said display screen presents a language selection menu, said voter manipulates said user selection device to select a desired one of said languages; and wherein said textual information and said audible help information are thereafter presented in said selected language.

22. Software for operating a voting station in an electronic voting system programmed for predetermined election contests taking place on a predetermined election day, said voting station including a display screen for displaying textual and pictorial information and a user selection device for selecting items from said textual and pictorial information to indicate preferences of a voter, said software operable to perform the steps comprising:
authorizing an identified voter to cast an anonymous ballot using said voting station;
said display screen presenting a slate of candidates for an elected office, each of said candidates being displayed as a selection item including at least a textual name identifier;
said voter manipulating said user selection device to select a desired one of said candidates;
said display screen presenting an enlarged representation of information corresponding to said desired candidate together with a confirmation selection item and a cancel selection item;
said voter manipulating said user selection device to select either said confirmation selection item or said cancel selection item;
if said cancel selection item is selected, then returning to presentation of said slate of candidates;
if said confirmation selection item is selected, then progressing through remaining election contests until said voter has confirmed a selection in each election contest;
said display screen presenting all voter selections on a review screen and presenting choices to said voter to change any of said selections;
said voter confirming no further changes; and
said voting station outputting said voter selections.
